(19) United States
(12) Patent Application Publication
(10) Pub. No.: US 2008/0258860 A1
(43) Pub. Date: Oct. 23, 2008

(54) Universal Light String Lamp Bypass Device

(76) Inventors: Matthew D. Collins, Macomb, MI (US); Rosanna Casciani-Collins, Macomb, MI (US)

Correspondence Address: GREGORY T. ZALECKI, 12900 HALL ROAD, SUITE 400, STERLING HEIGHTS, MI, 48313, US

(21) Appl. No.: 12/060,987

(22) Filed: Apr. 2, 2008

Related U.S. Application Data
(63) Continuation-in-part of application No. 11/737,867, filed on Apr. 20, 2007.

(51) Int. Cl. H01C 13/00

(52) U.S. Cl. 338/219

(57) ABSTRACT

A universal light string lamp bypass device is comprised of a plug and a resistor. The plug is shaped and sized to releasably fit within the base of a lamp assembly. The plug encapsulates the resistor with the resistor leads extending from the bottom end of the plug. When the encapsulated resistor is inserted into a lamp base it can be electrically connected to the lamp socket terminals. The impedance of the resistor substantially matches the impedance of an operating lamp within a lamp socket of the light string. Most lamp bases have a standard configuration for receiving a lamp. This device fits within a lamp base after the lamp has been removed. A section of a light string may be darkened by replacing its lamps with the device. A typical use is for the darkening of a section of a light string connecting two decorated bushes.

### CROSS-REFERENCE TO RELATED APPLICATIONS

This is a continuation-in-part of U.S. patent application Ser. No. 11/737,867 filed on Apr. 20, 2007.

### BACKGROUND

Light strings are commonly used to provide holiday decoration. They are often used during the Christmas season to decorate Christmas trees, shrubs, other types of trees and building structures.

A typical light string consists of 50 incandescent bulbs or lamps electrically connected in series. The light string is designed for connection to 120 volt rms AC line current. Each bulb is designed to operate with a 2.4 volt potential across its filament. The filament has a resistance of approximately 13.7 ohms when the lamp is operating. A typical light string operates at 175 milliamps and dissipates approximately 21 watts of power. When strings of more than 50 lamps are desired two or more light strings are electrically connected together.

Many modern light string use lamps having a shunt wire across the filament circuit. When the filament of such a lamp burns out a higher voltage across the shunt wire causes it to physically change such that a shunt circuit replaces the filament. This allows the series circuit of the light string to be uninterrupted even though the filament of a lamp has burned out resulting in an open filament circuit. If the lamp did not contain a shunt all of the lamps electrically connected together in series would fail to operate when the filament of one lamp burned out.

The lamps on most light strings are evenly spaced. As a result, areas that are not desired to be the lighted are often lighted anyway when trees, bushes, building structures, or the like are decorated with light strings. For example, two or more exterior bushes are often decorated with one or more light strings. When more than one light string is used, the strings are electrically connected together. The light string traverses the area between the bushes. This area between the bushes then becomes lighted when the light string operates. Many decorators want only the bushes to be lighted and not the area between the bushes. With traditional series connected light sets it is not possible to have an unlighted area between the bushes because this would require the removal of the lamps on the light string in that area. Once one lamp is removed the entire string becomes unlighted because the electrical series connection will have become interrupted. Thus, the decorator has no choice but to keep the area desired to be unlighted lighted. The same situation arises in the decoration of building structures with light strings. Areas desired to be unlighted must remain lighted in order to avoid interruption of the electrical series circuit of the light string.

Although lamps having a shunt wire reduce the problem of having the failure of one lamp cause the failure of the entire light string, the shunt wire lamps do not entirely eliminate the problem. If a lamp falls out or is removed from its socket, the series connection is interrupted and the light string fails to light. If the shunt wire fails to physically transform properly after failure of the filament, the light string fails to light. If a lamp is damaged in such a way that both the filament and the shunt wire are damaged, the light string fails to light.

What is needed is an unlighted device that can be releasably plugged into a lamp socket. The device would complete the series circuit with respect to that particular lamp socket. This would allow an unlighted section of a lamp string to be created. It would also allow an open lamp socket to receive the device and repair the series circuit interruption caused by the open lamp socket. Preferably, the unlighted device would fit within the base of a lamp assembly. This would allow one universally sized device to be used within a variety of lamp assembly bases which have differing external configurations. Most lamp assembly bases have a standard configured receptacle for receiving a standard sized lamp. However, the external configurations of many lamp assembly bases which fit into lamp sockets vary. Thus, while most lamp assembly bases will hold a standard sized lamp they only fit within a matching lamp socket. The user of a light string has ready access to bases which fit within the lamp sockets of the users light string. Since the bases have a receptacle which fits a standard sized lamp, a single bottom end configuration of a universal light string lamp bypass device will fit into most lamp bases.

### SUMMARY

These needs are satisfied by the light string lamp bypass device described herein. The device is intended to be inserted into a lamp socket of a light string. Light strings contain a plurality of lamp sockets. A typical light string contains 50 lamp sockets. Each lamp socket has a pair of terminals. The terminals supply electrical power to a lamp within the socket.

A light string lamp bypass device is comprised of a plug and a conducting member. The plug is shaped and sized to releasably fit within a lamp socket. The conducting member is attached to the plug. The conducting member is shaped, sized and positioned upon the plug such that the conducting member is electrically connected to the socket terminals when the plug is inserted into the lamp socket. When the plug is inserted into the lamp socket the conducting member is positioned below the top surface of the plug.

The primary use of a light string lamp bypass device is in conjunction with an alternating current series connected light string. Within this environment the capacitance and inductance associated with the conducting member are negligible. Thus, the impedance of the conducting member is substantially the same as the resistance of the conducting member. The light string contains a plurality of lamps. It is not unusual for the lamp filament to have a much higher resistance when the lamp is operating, as compared to when the lamp is cold and not operating. When the light string is operating the impedances of the lamps within it are very similar to each other. The impedance (and resistance) of the conducting member is selected to substantially match the impedance of an operating lamp within a lamp socket of the light string. Preferably, the impedance of the conducting member is between 1.5 ohms and 30 ohms.

A cap should be attached to the end of the plug opposite the conducting member. This facilitates the manual removal of the lamp bypass device from a socket into which it has been inserted. The device may be pried out of a lamp socket by inserting one's fingernail underneath the cap.

This invention also encompasses a universal light string lamp bypass device. A universal light string lamp bypass device is intended to be inserted into a lamp assembly base. Typical light strings use lamp assemblies which plug into light string lamp sockets. The lamp assemblies are comprised of a lamp and a base. The lamp has two electrical leads extending from its bottom end. The lamp is seated within the base while the electrical leads of the lamp extend through openings within the base. The leads are bent upwards along the side periphery of the base to form electrical contact points for the lamp socket terminals and to retain the lamp within the base. The lamp may be easily removed from the base by straightening the electrical leads so that they easily recede from the base openings when the lamp is pulled away from the base.

A universal light string lamp bypass device is comprised of a resistive element and a plug. The resistive element has a pair of leads for connecting the resistive element in a circuit. The plug encapsulates the resistive element such that the resistive element leads extend from a bottom end of the plug. The bottom end of the plug is shaped to releasably fit within a lamp assembly base while each resistive element lead extends through an opening within the base. The resistive element leads are adapted such that each resistive element lead will extend through an opening within the base and contact a terminal within a lamp socket when the resistive element encapsulated plug and the base are inserted into the lamp socket. The upper end of the plug may have one or more grasping ridges for facilitating the removal of the plug. A flange may be positioned between the lower end of the plug and the upper end of the plug such that the flange rests upon the outer periphery of the base when the plug is inserted into the base. This will allow the depth of insertion of the plug into the base to be determined. It will also facilitate removal of the plug. Preferably, the resistive element is a carbon film resistor having an impedance which substantially matches the operating impedance of a lamp which has been removed from the base. An impedance range between 1.5 ohms and 200 ohms will match the operating impedance of the lamps of most light strings. The universal light string lamp bypass device may be manufactured and distributed with or without an attached lamp assembly base.

Two or more light strings may be electrically connected together. This allows a decorator to decorate with one or more light strings. The decorator may desire to darken a section of a lighted light string comprised of a plurality of lamps electrically connected in series. In order to accomplish this the decorator selects a section of the light string for darkening. The lamps within that section are identified. Each lamp identified within the section of the light string to be darkened is replaced with a light string lamp bypass device as described.

### DRAWINGS

These and other features, aspects, and advantages of the present invention will become better understood with regard to the following description, appended claims, and accompanying drawings where:

FIG. 1 is an elevation view of two bushes decorated with a light string showing a darkened section of the light string between the bushes produced by inserting light string lamp bypass devices into the lamp sockets of the light string which are positioned between the bushes.

FIG. 2 is an exploded perspective view of a light string lamp bypass device, lamp socket and lamp socket terminals.

FIG. 3 is an elevation view of the light string lamp bypass device of FIG. 2.

FIG. 4 is a top view of the light string lamp bypass device of FIG. 2.

FIG. 5 is an electrical diagram showing three sets of series connected lamp light strings.

FIG. 6 is another electrical diagram showing two sets of series connected lamp light strings.

FIG. 7 is an elevation view showing the light string lamp bypass device of FIG. 2 inserted into the lamp socket of FIG. 2.

FIG. 8 is an elevation view of an alternate embodiment of a light string lamp bypass device.

FIG. 9 is an exploded perspective view of an alternate embodiment of a light string lamp bypass device, lamp socket and lamp socket terminals.

FIG. 10 is a perspective view of the light string lamp bypass device of FIG. 3, showing an alternate embodiment for the conducting member.

FIG. 11 is a perspective view of a universal light string lamp bypass device.

FIG. 12 is a perspective view of the universal light string lamp bypass device of FIG. 11 showing an encapsulated resistor in phantom.

FIG. 13 is an exploded perspective view of the universal light string lamp bypass device of FIG. 11 which also shows a lamp assembly base and a lamp socket.

FIG. 14 is a sectional view of the universal light string lamp bypass device, lamp assembly base and lamp socket of FIG. 13 wherein the universal light string lamp bypass device has been inserted into the lamp assembly base and the base and bypass device have been inserted into the lamp socket.

### DESCRIPTION

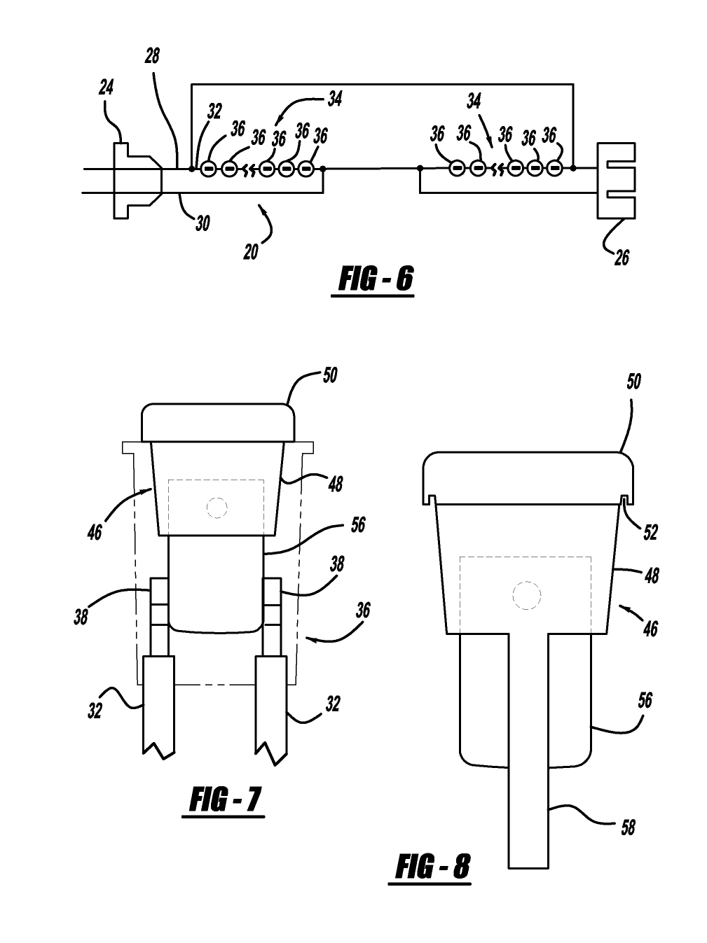

A light string lamp bypass device 46 is intended to be inserted into a lamp socket 36 of a light string 20. Electrical diagrams of two typical light strings 20 are shown in FIG. 5 and FIG. 6. The light strings 20 receive their power from traditional residential or commercial electrical outlets. A line voltage electrical plug 24 is adapted to be inserted into an electrical outlet. Optionally, the light string 20 has a line voltage electrical socket 26 which is electrically connected to the output of the line voltage electrical plug 24. Light strings 20 may be connected to each other by inserting the line voltage electrical plug 24 of one light string 20 into the line voltage electrical socket 26 of another light string 20 to produce a combined light string. A first line voltage wire 28 and a second line voltage wire 30 exit from the line voltage electrical plug 24. If the light string 20 includes a line voltage electrical socket 26, the appropriate electrical connection is made between the first line voltage wire 28, the second line voltage wire 30 and the line voltage electrical socket 26, as shown in FIG. 6. A series wire 32 branches off from one of the line voltage wires, as shown in FIG. 5 and FIG. 6. The series wire 32 is used to connect a plurality of lamp sockets 36 in series. Each lamp socket 36 has a pair of terminals 38 which are connected to the series wire 32. The terminals 38 supply electrical power to a lamp 42 inserted into the lamp socket 36. Sets of series connected lamps 34 are fabricated by connecting a plurality of lamp sockets 36 and lamps 42 in series, as shown in FIG. 5 and FIG. 6. A typical set of series connected lamps 34 consists of 50 lamps.

FIG. 5 also shows a lamp 42 inserted into one lamp socket 36 and a light string lamp bypass device 46 inserted into another lamp socket 36. The lamp 42 produces light when a voltage is applied across the filament 44 of the lamp 42.

A typical light string 20 consists of 50 2.4 volt lamps 42 connected in series. The typical light string 20 dissipates 21 watts of power and uses 175 milliamps of current when connected to a 120 volt alternating current electrical outlet.

A light string lamp bypass device 46 is comprised of a plug 48 and a conducting member 56.

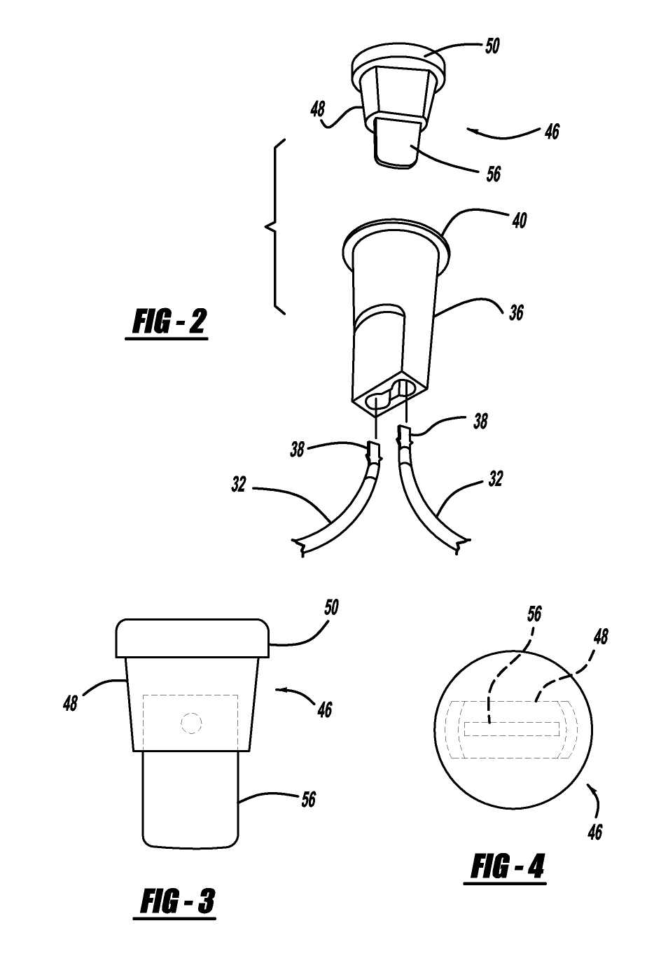

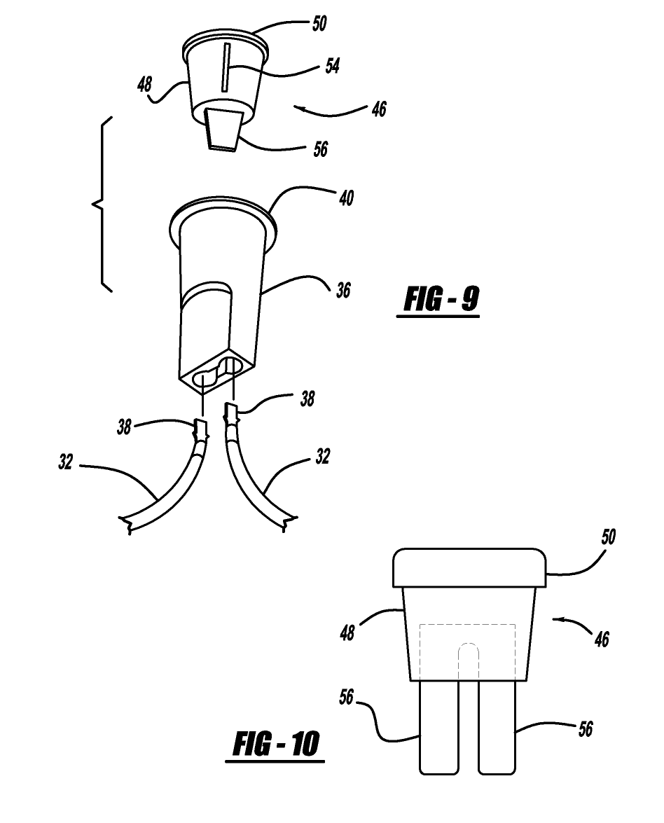

The plug 48 is shaped and sized to releasably fit within a lamp socket 36. Many lamp sockets 36 are tapered. Therefore, a plug 48 intended for use within such a socket 36 should also be tapered. Tapered plugs 48 are shown in FIG. 2, FIG. 3, FIG. 4, FIG. 7, FIG. 8, FIG. 9 and FIG. 10. The plug 48 should be sized and shaped such that it will be securely retained within the lamp socket 36 when pushed therein, yet removable with a manual prying action. A releasable fit may be facilitated by fitting the plug 48 with an interlocking ridge 54, as shown in FIG. 9. With this feature the lamp socket 36 is provided with a matching recess which mates with the interlocking ridge 54.

Preferably, a cap 50 is attached to the end of the plug 48 which is opposite the conducting member, as shown in FIG. 2. The cap 50 is adapted to facilitate the manual removal of the lamp bypass device 46 from a socket 36. This can be accomplished by sizing and shaping the cap 50 such that a person may insert his or her fingernail between the cap 50 and the lamp socket 36 in order to exert a removal force upon the plug 48. Optionally, the cap 50 may be formed with a fin projecting away from the plug 48. The fin would be adapted to facilitate it being manually grasped for removing the light string lamp bypass device 46 from a lamp socket 36.

The light string lamp bypass device 46 and lamp socket 36 may be made waterproof by incorporating the improvements taught by Peng in U.S. Pat. No. 5,700,082, which is incorporated by reference. These improvements include a recess 52 within the underside of the cap 50, as shown in FIG. 8. The recess 52 interlocks with a rim 40 surrounding the opening of the lamp socket 36. The rim 40 is shown in FIG. 2. Additionally, the plug 48 or the conducting member 56 may have a rod 58 attached to it, as shown in FIG. 8. When the plug 48 is pushed into the lamp socket 36, the rod 58 separates the series wires 32 and seals the wire opening holes within the bottom of the lamp socket 36. Preferably, the rod 58 is provided with semicircular grooves at the surfaces where the rod 58 interfaces with the series wires 32.

The preferred material for fabrication of the plug 48 and the cap 50 is plastic. However, it should be clear that many other types of materials may be used. The conducting member 56 should be provided with a hole, as shown in FIG. 3. This will permit a secure bond between the plug 48 and the conducting member 56 when the light string lamp bypass device 46 is fabricated by molding a plastic plug 48 around a conducting member 56.

The purpose of the conducting member 56 is to complete the circuit between the terminals 38 of a lamp socket 36 into which the conducting member 56 is inserted. Ideally, the conducting member is metallic or carbon based. The conducting member 56 is shaped, sized and positioned upon the plug such that the conducting member is electrically connected to the socket terminals 38 when the plug 48 is inserted into the lamp socket 36. The conducting member 56 is positioned below the top surface of the plug 48 and is positioned between the socket terminals 38 when the plug 48 is inserted into the lamp socket 36. These conditions are met by the light string lamp bypass devices 46 shown in FIG. 2, FIG. 3, FIG. 4, FIG. 7, FIG. 8, FIG. 9 and FIG. 10. So long as the conducting member 56 does not pierce through the top of the light string lamp bypass device 46 it is considered to be positioned below the top surface of the plug 46.

The resistance of the conducting member 56 may be controlled by controlling the shape of the conducting member 56 and by controlling the material from which the conducting member 56 is fabricated. For example, different resistances of the conducting member 56 shown in FIG. 10 may be obtained by selecting different heights, widths and thicknesses of the legs and connecting neck of that conducting member 56.

When a light string 20 is operating a plurality of lamps 42 within the light string 20 are operating and are lit. The lit lamps 42 have similar impedances. As described above, in this context the term impedance and resistance are virtually the same. The current draw, power dissipation, total string impedance and individual lamp impedance may be computed for various light string 20 configurations. Assuming that the total impedance is provided by the lamps 42, that the light string 20 is connected to a 120 volt rms alternating current source, and that the string contains 50 lamps 42, the current draw, power dissipation, total string impedance and individual lamp impedance would be as follows:

| | power | total string | individual lamp |
|---|---|---|---|
| current draw | dissipation | impedance | impedance |
| (amps) | (watts) | (ohms) | (ohms) |
| 3 | 360 | 40 | .8 |
| 2 | 240 | 60 | 1.2 |
| 1.2 | 144 | 100 | 2 |
| 1 | 120 | 120 | 2.4 |
| .5 | 60 | 240 | 4.8 |
| .34 | 40.8 | 350 | 7 |
| .30 | 36 | 400 | 8 |
| .175 | 21 | 685.7 | 13.7 |
| .08 | 9.6 | 1500 | 30 |

A typical light string draws 175 milliamps and dissipates 21 watts. This means that the average lamp 42 impedance is 13.7 ohms. Most light strings 20 have lamps with impedances between 1.5 ohms and 30 ohms. The impedance referred to is the impedance when the lamp 42 is lit and operating, as opposed to the impedance when the lamp 42 is not operating. Preferably, the impedance of the conducting member 56 substantially matches the impedance of an operating lamp 42 within a lamp socket 36 of the light string 20. For 50 lamp 42 light strings 20 operating on 120 volt alternating current the impedance of the conducting member 56 should be, but is not required to be, between 1.5 ohms and 30 ohms. The light string lamp bypass device 46 will operate when the impedance of the conducting member 56 is between 0 and 1.5 ohms. However, if a large number of light string lamp bypass devices 20 with very low impedance conducting members 56 are used on a light string 20, the voltages across the remaining lamps 42 will increase causing an increased light intensity along with a decreased life expectancy of the lamp 42.

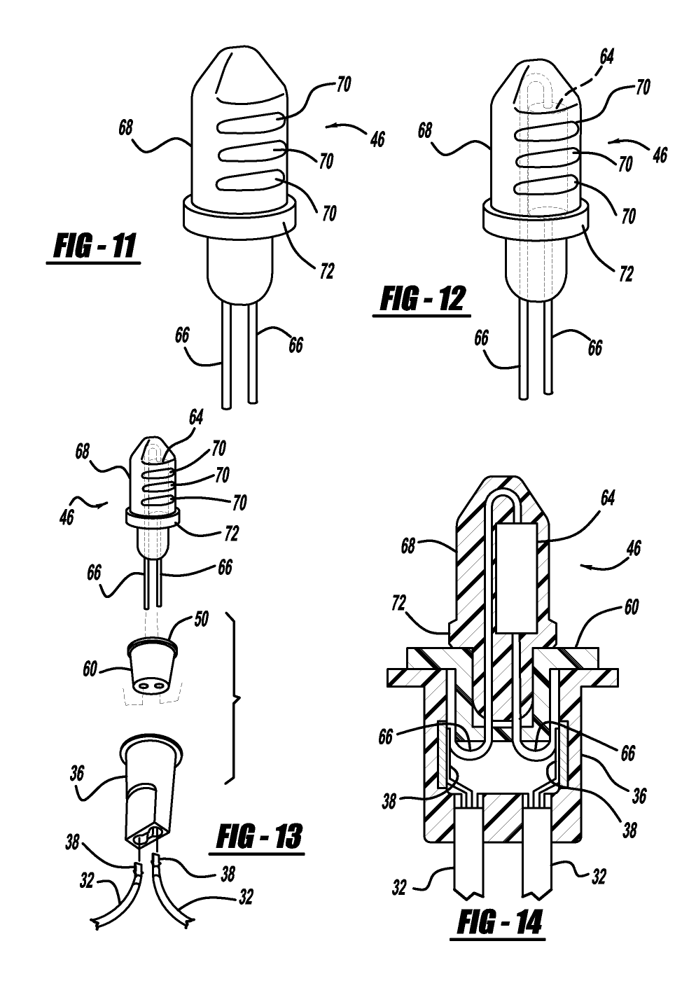

A preferred embodiment of a universal light string lamp bypass device 46 is shown in FIGS. 11-14. FIG. 13 shows a base 60 of a lamp assembly. A typical lamp assembly is comprised of a lamp 42 and a base 60. The lamp 42 has two leads extending from its bottom end. These leads pass through openings within the bottom of the base 60. The lamp leads are bent upwards such that they form contact points for the lamp socket terminals 38 and such that they retain the lamp 42 within the base 50. A universal light string lamp bypass device 46 is intended to be inserted into a lamp assembly base 60 after the lamp 42 has been removed. This is depicted in an exploded view in FIG. 13. The universal light string lamp bypass device 46 optionally includes the base 60.

A universal light string lamp bypass device 46 is comprised of a resistive element 64 and an encapsulating plug 68. Preferably, the resistive element 64 is a resistor. The resistive element 64 has a pair of electrical leads 66 extending from it. The electrical leads 66 permit the resistive element 64 to be electrically connected in a circuit. The use of a resistive element 64 permits enhanced matching of the impedance of the resistive element 64 with the operating impedance of a lamp 42 which the resistive element 64 replaces. The operating impedance of a lamp 42 is the impedance exhibited by the lamp 42 when it is operating (lighted). By matching the impedance of the resistive element 64 with the operating impedance of the lamp 42 which it replaces, the electrical characteristics of the light string 20 will remain unchanged when a resistive element 64 is electrically substituted for a lamp 42 in the light string 20. The resistive element 64 shown in FIGS. 12-14 is a carbon film resistor 64. The carbon film resistor 64 has two axial leads 66. The resistor leads 66 have been formed so that they extend downward in a parallel configuration, as shown in FIG. 12. This has been accomplished by bending the top lead 66. In our prototype the resistor 64 is rated at 8 ohms and four watts with a 10% resistance tolerance. Other types of resistors 64, such as ceramic wire wound resistors, with different resistances and power ratings may also be used. However, we have found that a thin-film carbon resistor 64 allows for the best replication of the shape and size of the universal light string lamp bypass device 46 to the lamp and base assembly shape and size which it replaces.

The plug 68 encapsulates the resistive element 64. The resistive element leads 66 extend through the bottom end of the plug 68. Ideally, approximately 8 mm of each lead 66 remains unencapsulated. These unencapsulated leads 66 are configured to fit through the openings within the base 60. The bottom end of the plug 68 is shaped to releasably fit within the lamp assembly base 60 when the resistive element leads 66 each extend through an opening within the base 50, as shown and FIGS. 13 and 14. In order to use the universal light string lamp bypass device 46 a base 60 is obtained—typically by removing a lamp 42 from its base 60. The leads 66 of the resistive element 64 are threaded through the openings within the base 60 while the bottom end of the plug 68 is inserted into the base 60. The resistive element leads 66 are adapted such that each resistive element lead 66 will extend through an opening within the base 60 and contact a terminal 38 within a lamp socket 36 when the resistive element encapsulated plug 68 and base 60 are inserted into the lamp socket 36, as shown in FIG. 14. As can be seen in FIG. 14 the unencapsulated portion of the resistive element leads 66 are bent upwards. This forms contact points between the resistive element leads 66 and the lamp socket terminals 38, as shown in FIG. 14. The upward bending of the leads 66 also retains the universal light string lamp bypass device 46 within the base 50. The base 50 may have the waterproof features previously described.

The encapsulating plug 68 may be fabricated by plastic molding. A polycarbonate or polypropylene material may be used. One or more grasping ridges 70 should be formed into the upper end of the encapsulating plug 68, as shown in FIG. 11. The grasping ridges 70 shown in FIG. 11 are in the form of bulges which project outwardly. The grasping ridges 70 may also be in the form of indentations within the encapsulating plug 68. The grasping ridges 70 facilitate removal of the plug. Preferably, a flange 72 is positioned between the lower end of the encapsulating plug 68 and its upper end such that the flange 72 rests upon the outer periphery of the base 60 when the encapsulating plug 68 is inserted into the base 60. This permits the determination of the depth of insertion of the encapsulating plug 68 into the base 60. It also facilitates removal of the encapsulating plug 68 from the base by providing a prying surface.

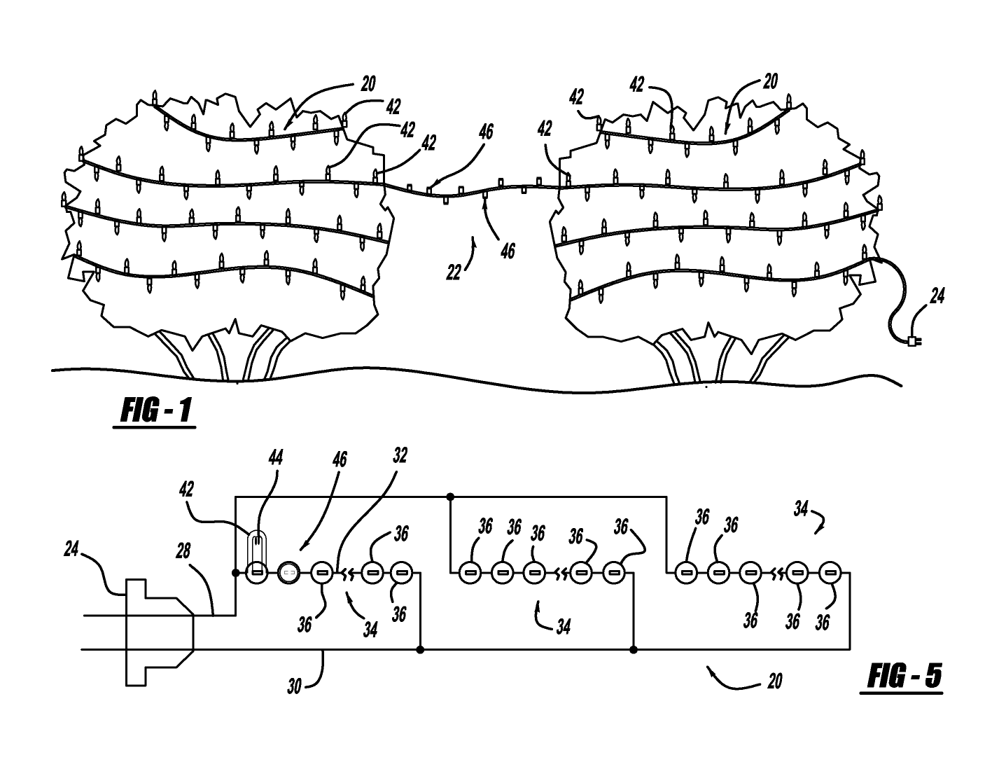

A typical use for light string lamp bypass devices 46 is shown in FIG. 1. A light string 20 is used to decorate two bushes. A darkened section 22 of the light string 20 has been selected. The darkened section 22 is between the bushes. Lamps 42 within the darkened section 22 have been identified and removed from their respective lamp sockets 36. Each lamp 42 within the darkened section 22 of the light string 20 has been replaced with a light string lamp bypass device 46. The light string lamp bypass devices 46 provide continuity to the series lamp circuit. As a result, the lamps 42 on the bushes remain lighted while the darkened section 22 of the light string 20 remains darkened.

A light string lamp bypass device 46 may also be used to fill a lamp socket 36 from which a lamp 42 has fallen out or otherwise been removed. The light string lamp bypass device 46 will allow the remaining lamps 42 to operate by completing the series lamp circuit.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention. The phrase “consisting essentially of” when used within the claims is meant to exclude other elements having any essential significance to the combination. For example, claims using this phrase are meant to exclude lamp shunts and lamp filaments. The phrase is not meant to exclude elements which do not materially affect the basic and novel characteristics of the claimed invention.

What is claimed is:

1. A universal light string lamp bypass device for insertion into a lamp assembly base, said universal light string lamp bypass device consisting essentially of:
(a) a resistor having a pair of leads for connecting the resistor in a circuit;
(b) a plug encapsulating the resistor such that the resistor leads extend from a bottom end of the plug;
(c) the bottom end of said plug being shaped to releasably fit within the lamp assembly base with each resistor lead extending through an opening within the base; and
(d) wherein the resistor leads are adapted such that each resistor lead will extend through an opening within the base and contact a terminal within a lamp socket when the encapsulated resistor and base are inserted into the lamp socket.

2. The universal light string lamp bypass device of claim 1, wherein the upper end of the plug has one or more grasping ridges for facilitating the removal of the plug.

3. The universal light string lamp bypass device of claim 1, further comprising a flange positioned between the lower end of the plug and the upper end of the plug such that said flange rests upon the outer periphery of the base when the plug is inserted into the base, for determining the depth of insertion of the plug into the base and for facilitating, removal of the plug.

4. The universal light string lamp bypass device of claim 1, wherein the resistor is a carbon film resistor.

5. The universal light string lamp bypass device of claim 1, wherein the impedance of the resistor substantially matches the operating impedance of a lamp which has been removed from the base.

6. The universal light string lamp bypass device of claim 1, wherein the impedance of the resistor is between 1.5 ohms and 200 ohms.

7. The universal light string lamp bypass device of claim 1, further comprising a lamp assembly base into which the bottom end of the plug has been inserted and through openings in which the resistor leads extend.

8. A method for darkening a section of a lighted light string comprised of a plurality of lamps electrically connected in series, said method comprising:
(a) selecting a section of the light string for darkening;
(b) identifying the lamps within the section of the light string to be darkened; and
(c) replacing each lamp identified within the section of the light string to be darkened with the universal light string lamp bypass device of claim 1 which has been inserted into a lamp assembly base.
